(19) United States
(12) Patent Application Publication
(10) Pub. No.: US 2026/0154788 A1
(43) Pub. Date: Jun. 4, 2026

(54) METHOD AND DEVICE FOR GENERATING A DIMMING MAP BASED ON A LIGHTWEIGHT DEEP NETWORK

(71) Applicant: InterDigital CE Patent Holdings, SAS, Paris (FR)

(72) Inventors: Olivier Le Meur, TALENSAC (FR); Claire-Helene Demarty, MONTREUIL LE GAST (FR); Laurent Blonde, THORIGNE-FOUILLARD (FR); Erik Reinhard, HEDE-BAZOUGES (FR); Franck Aumont, VERN SUR SEICHE (FR)

(21) Appl. No.: 19/130,802

(22) PCT Filed: Nov. 20, 2023
(86) PCT No.: PCT/EP2023/082360

§ 371 Date: May 16, 2025

(30) Foreign Application Priority Data
Nov. 22, 2022 (EP) 22306719.0
Feb. 10, 2023 (EP) 23305185.3

(51) Int. Cl. G06T 5/60; G06T 3/4046; G06T 5/70

(52) U.S. Cl. CPC G06T 5/60; G06T 3/4046; G06T 5/70; G06T 2207/20016; G06T 2207/20081; G06T 2207/20084

(57) ABSTRACT

A method and device allow to reduce the pixel values an input image by combining a dimming map to the input image. This results in reducing the energy consumption required to display the dimmed image while preserving as much as possible the quality of experience when displaying the dimmed image. The reduction of the pixel values can be done by either reducing the luminance and optionally the chrominance or reducing the color components of the image. The dimming map is generated by a lightweight deep learning network based on a small set of parameters and with a target pixel values reduction rate. The generated dimming map aims at preserving visual similarity and is explicitly conditioned to respect specific constraints. For example, a smoothness constraint allows to the dimming map to be robust to downsampling. Two architectures and two training methods are proposed.

This application claims the priority to European Application No 22306719.0 filed 22 Nov. 2022 and European Application No 23305185.3 filed 10 Feb. 2023, which are incorporated herein by reference in their entirety.

### TECHNICAL FIELD

At least one of the present embodiments generally relates to reducing energy consumption in display devices and more particularly to the generation of a dimming map based on a lightweight deep network, the dimming map allowing to reduce the energy needed for rendering an image by reducing the pixel values of the image.

### BACKGROUND

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and in the near future to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc.). Indeed, displays are the most important source of energy consumption, for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

Organic Light Emitting Diode (OLED) is one example of display technology that is getting more and more popular because of numerous advantages compared to former technologies such as Thin-Film Transistor Liquid Crystal Displays (TFT-LCDs). Rather than using a uniform backlight, OLED displays are composed of individual LEDs as image pixels. OLEDs power consumption is therefore highly correlated to the image content and the power consumption for a given input image can be estimated by considering the values of the displayed image pixels.

### SUMMARY

Embodiments described hereafter have been designed with the foregoing in mind and introduce the notion of dimming map. The described methods and devices allow to reduce the pixel values of the image by combining a dimming map to the input image. This results in reducing the energy consumption required to display the dimmed image while preserving as much as possible the quality of experience. The reduction of the pixel values can be done by either reducing the luminance and optionally the chrominance or reducing the color components of the image. The dimming map is generated by a lightweight deep learning network based on a small set of parameters and with a target pixel values reduction rate. The generated dimming map aims at preserving visual similarity and is explicitly conditioned to respect specific constraints. For example, a smoothness constraint allows the dimming map to be robust to downsampling operations. Two architectures and two training methods are proposed.

A first aspect of at least one embodiment is directed to a method comprising obtaining an input image, determining a dimming map for the input image using a lightweight deep learning network, wherein combining the dimming map to the input image results in a modified image with reduced pixel values while preserving the visual similarity between the two images.

A second aspect of at least one embodiment is directed to a device comprising a processor configured to obtain an input image and determine a dimming map for the input image using a lightweight deep learning network, wherein combining the dimming map to the input image results in a modified image with reduced pixel values while preserving the visual similarity between the two images.

In a first variant of the first or the second aspects, the pixel value reduction is done by reducing the luminance of the input image and the model of the deep learning network is trained with multiple content losses comprising at least a mean absolute error characterizing the difference of luminance between an input image and the corresponding modified image, a perceptual error loss characterizing the difference between extracted features of an input image and the extracted features of the corresponding modified image, a power loss characterizing the difference of power between an input image and the corresponding modified image and a total variation loss characterizing the smoothness of the dimming map.

In a second variant of the first or the second aspects, the pixel value reduction is done by reducing the luminance and the chrominance of the input image and the model of the deep learning network is trained with multiple content losses comprising at least a mean absolute error characterizing the difference of luminance and chrominance between an input image and the corresponding modified image, a perceptual error loss characterizing the difference between extracted features of an input image and the extracted features of the corresponding modified image, a power loss characterizing the difference of power between an input image and the corresponding modified image and a total variation loss characterizing the smoothness of the dimming map.

In a third variant of the first or the second aspects, the pixel value reduction is done by reducing the color components of the input image and the model of the deep learning network is trained with multiple content losses comprising at least a mean absolute error characterizing the difference of color component values between an input image and the corresponding modified image, a perceptual error loss characterizing the difference between extracted features of an input image and the extracted features of the corresponding modified image, a power loss characterizing the difference of power between an input image and the corresponding modified image and a total variation loss characterizing the smoothness of the dimming map.

In further variants of the first or second aspects and of the variants of the first or second aspects, the model of the deep learning network is trained with a limited number of trainable parameters for example less than 2000 trainable parameters, the model uses an architecture comprising only nine layers, most layers of the model use four or eight channels, the model uses an Atrous spatial pyramid pooling layer.

In further variants of the first or second aspects and of the variants of the first or second aspects, the model of the deep learning network is trained with a limited number of trainable parameters for example less than 5000 trainable parameters, the model uses an architecture comprising only eleven layers, most layers of the model use four or eight channels, the model uses an Atrous spatial pyramid pooling layer.

In a further variant of the first or second aspects and of the variants of the first or second aspects, the dimming map is scaled linearly to obtain a smaller reduction.

In further variants of the first or second aspects and of the variants of the first or second aspects, the dimming map is combined with the input image by adding or by subtracting or by multiplying the values of the dimming map to the luminance values of the input image. In the first case, the values of the dimming map are negative or null. In the second case, the values of the dimming map are positive or null. In the third case, the values of the dimming map are in a range between zero and one.

A third aspect of at least one embodiment is directed to a computer program comprising program code instructions executable by a processor, the computer program implementing at least the steps of a method according to the first aspect or one of its variants.

A fourth aspect of at least one embodiment is directed to a non-transitory computer readable medium comprising program code instructions executable by a processor, the computer program product implementing at least the steps of a method according to the first aspect or one of its variants.

### BRIEF DESCRIPTION OF THE DRAWINGS

The invention can be better understood with reference to the following description and drawings, given by way of example and not limiting the scope of protection, and in which:

FIG. 1 illustrates a block diagram of an example of display device in which various aspects and embodiments are implemented.

FIG. 2 illustrates a first example of a general architecture based on a lightweight deep network for generating a dimming map according to at least one embodiment.

FIG. 3 illustrates the PSNR distribution against pixel value reduction rates according to at least one embodiment using the first architecture compared to the R-ACE solution.

FIG. 4 illustrates the average pixel value reduction against target pixel value reduction rates according to at least one embodiment using the first architecture compared to the R-ACE solution.

FIG. 5 illustrates a second example of a general architecture based on a lightweight deep network for generating a dimming map according to at least one embodiment.

FIG. 6 illustrates an example of combination of channel attention and spatial attention.

FIG. 7 illustrates a PSNR diagram according to at least one embodiment using the second architecture compared to the R-ACE solution.

FIG. 8 illustrates a SSIM diagram according to at least one embodiment using the second architecture compared to the R-ACE solution.

FIG. 9 illustrates a LPIPS diagram according to at least one embodiment using the second architecture compared to the R-ACE solution.

FIG. 10 illustrates an average pixel value reduction against target pixel value reduction rates according to at least one embodiment using the second architecture compared to the R-ACE solution.

FIG. 11 illustrates an example process for training a lightweight deep learning model according to at least one embodiment.

FIG. 12 illustrates an example process for generating an image with reduced pixel value based on a lightweight deep learning model according to at least one embodiment.

The drawings are for purposes of illustrating examples of various aspects, features, and embodiments in accordance with the present disclosure and are not necessarily the only possible configurations.

### DETAILED DESCRIPTION

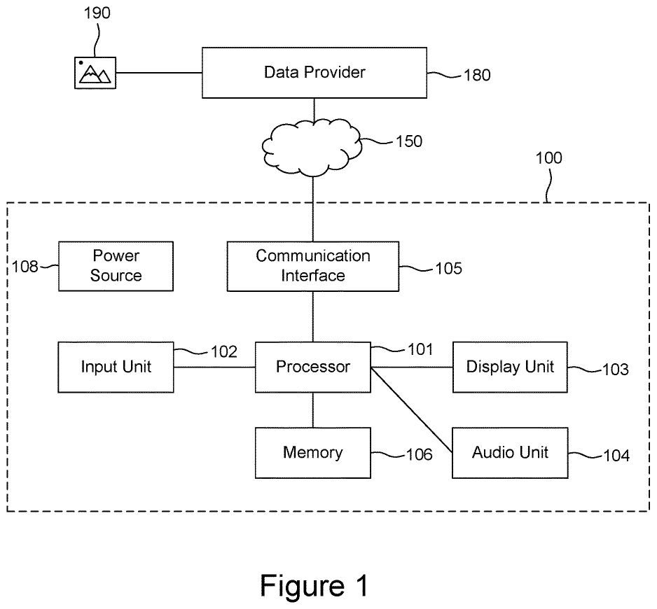

FIG. 1 illustrates a block diagram of an example of display device in which various aspects and embodiments are implemented. In the depicted environment, a user interacts with the display device 100 that is connected to a data provider 180 through a communication network 150.

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the pixel value reduction process 1200 of FIG. 12.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication network 150 preferably uses a communication standard to provide interoperability between content provider and display devices. Such communication standard may be wireless, such as cellular (e.g., LTE) communications, Wi-Fi communications, and the like, to ensure the mobility of the display device. Cable, satellite, or terrestrial digital television broadcast communication may also be used for the communication network 150 as well as broadband television communications. Such digital television standards may on based on well-established standards like DVB, ATSC, or the like. General purpose network standards may also be used, for example based on Ethernet.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

In at least one embodiment, the processor 101 of the display device 100 is configured to display on the display unit 103 an obtained image according to embodiments described further below, in other words altering an original version of the image to allow a reduction of the pixel values of the image that results into a reduced energy consumption of the display device when compared to displaying the original image. In a variant embodiment, the image 190 is obtained from the data provider 180 through the communication network 150. In another variant embodiment, the image is obtained from the memory 106, stored for example after being captured by the input unit 102.

Typical examples of device 100 are smartphones, tablets, laptops, external monitors, head-mounted displays, television set, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure. In at least one embodiment, the device does not include a display unit but prepares data for display so that another device, such as a screen, can perform the display. Example of such devices are set top boxes, media players, desktop computers, encoders, decoders, servers, computing grids, cloud computers, etc.

The design of the proposed embodiments has been driven by several requirements and constraints, namely optimization of the quality of experience (QoE), reduction of memory and energy footprint, and flexibility/adaptability. The main objective of the embodiments is to preserve as much as possible the visual quality of the resulting image while reducing its energy consumption on displays. Meanwhile, in the context of an energy-aware approach, it is also important to design a memory-frugal, energy-frugal and flexible approach.

Regarding the memory and energy requirements, these are strongly linked to the number of trainable parameters of the deep network. Therefore, the embodiments described below limit this number in order to reduce the memory footprint and the energy consumption, and to maximize the opportunity to deploy the deep network in different environments, such as embedded hardware environments, video encoding environments or display environments. Furthermore, the embodiments described below propose a network that can be learned globally once on a training dataset and not learned for each new image.

Regarding the flexibility/adaptability requirement, the embodiments described below propose the computation of a pixel-wise dimming map that meets some constraints and allows specific use-cases. For instance, given a first dimming map determined according to embodiments described below and computed for an R₀ consumption saving (e.g., 20%), a second dimming map can be inferred from this first dimming map for a reduction rate R₁ (e.g., 10%) smaller than R₁. It means that there is no need to recompute the dimming map for different reduction rates, which thus increases the flexibility.

In addition, the embodiments described below propose to constrain the dimming map computation to be smooth thanks to explicit regularization during the training. It allows several benefits. First this will enforce the local variations to be small. Second, in the case of natural images with regions of piece-wise constant luminance, it will limit local visual annoyance in those regions. Beyond this point, enforcing explicitly piece-wise properties during the training provides interesting properties with respect to encoding/transmitting operations. The regularized dimming map may reduce the complexity as well as the needed bitrate, leading to a reduction of energy consumption. Finally, this kind of map can be easily modulated to take into account saliency information, regions of interest or any pixel-wise information.

Embodiments below describe a method and lightweight deep learning network to reduce the energy consumption required to display an image by reducing the pixel values of an image while preserving as much as possible the quality of experience when displaying the energy-reduced image. This is made possible since, as introduced earlier, the energy consumption for displaying an image on a display device is highly correlated to the pixel values of the image to be displayed, as a result of the physical characteristics and the architecture of display devices.

This luminance reduction is done by determining a dimming map to be combined with the image. The energy reduction may be achieved for a target reduction rate, for example comprised between 1% and 50%. Typical energy reduction rates would be in the range of 5 to 20%.

Compared to the conventional methods for reducing the luminance of an image, the embodiments present several advantages. Firstly, the lightweight deep learning network is based on a reduced set of parameters so that the amount of energy required for handling the deep network is kept small. Secondly, the generated dimming map targets the preservation of visual similarity. Thirdly, the dimming map is explicitly conditioned to have specific properties to respect at least one constraint. A first constraint is related to smoothness: making the dimming map smooth allows it to be robust to further processing such as downsampling. A second constraint is to guarantee that the downscaling/upscaling operation is seamlessly invertible. Fourthly, the dimming map can be used for different energy reduction factors (different from the energy reduction factor used for training the network). Fifthly, the proposed method is weakly conditioned compared to conventional methods: the targeted energy consumption is not directly embedded in the model of the deep learning network through specific layers.

Two different lightweight deep learning network architectures and two different training methods are described hereunder. Although the first architecture is described in conjunction with the first training method and the second architecture is described in conjunction with the second training method, the training methods are interchangeable so that the second training method can be used with the first architecture and the first training method can be used with the second architecture.

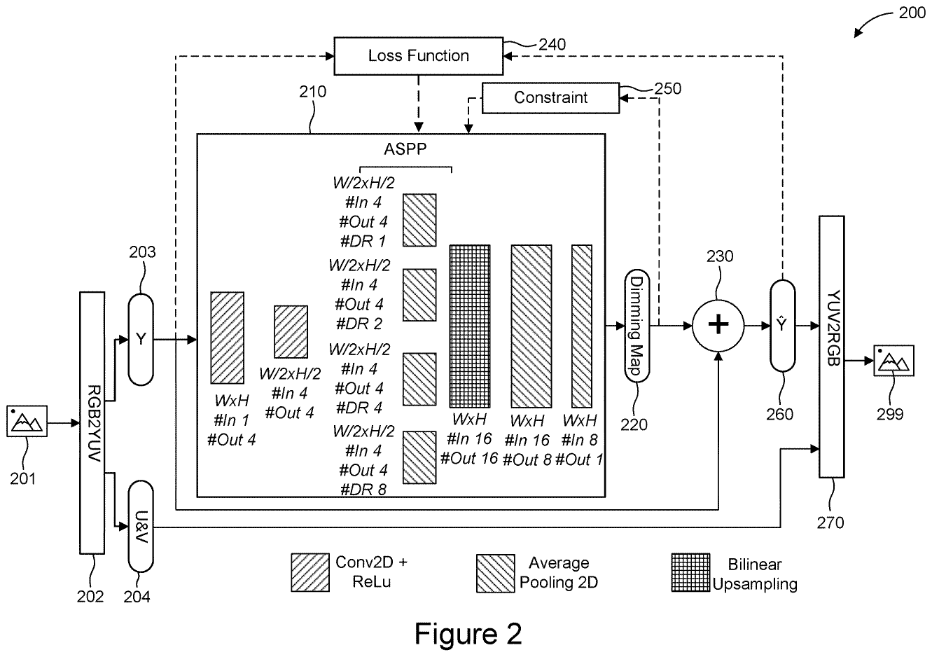

FIG. 2 illustrates a first example of a general architecture based on a lightweight deep network for generating a dimming map according to at least one embodiment. The first architecture 200 is built around a lightweight deep network 210 that has been trained to generate a dimming map for input images according to a combination of loss functions 240 with at least one constraint 250. Loss functions operate on differences between characteristics of an input image and characteristics of the corresponding output image. The constraint applies to the dimming map itself. In the embodiment of FIG. 2, the reduction of the pixel values of the image is done by modifying the luminance of the pixels of the image. An original image 201 is first split into luminance data 203 and U&V data 204, for example using a conventional RGB2YUV function 202. The luminance data 203 is provided to the lightweight deep network 210 that generates a dimming map 220. The dimming map is then combined 230 with the luminance data to determine the dimmed luminance Ŷ 260. The dimmed luminance is then combined with the UV data 204 to form the resulting dimmed image 299, for example using a conventional YUV2RGB function 270. This resulting image is perceptually similar to the original image 201, thus preserving the quality of experience. However, the luminance of the resulting image (i.e., its light level) is decreased so that displaying this image will require less energy than displaying the original image.

The first deep network architecture of FIG. 2 is a lightweight architecture comprising significant difference compared to more conventional implementations such as R-ACE (Residual Adaptative Contrast Enhancement) disclosed in “R-ACE network for OLED image power saving”, by Kuntoro Adi Nugroho and Shanq-Jang Ruan published in 2022 IEEE 4th Global Conference on Life Sciences and Technologies). It can provide a powerful and shallow network with less than 2000 trainable parameters and that reduces the energy of an image while maintaining its QoE. In this figure, each block of the network 210 represents 2D convolution layers. The parameters of these layers are the kernel size (e.g. 3×3), the stride (e.g., 2) to perform a spatial downsampling (for example W×H for a normal size, W/2×H/2 for a downscaled version, half the size in both dimensions), the number of inputs (for example #IN 4 for 4 inputs) and outputs (for example #OUT 4 for 4 outputs) as well as the dilation rate (#DR) for some of the blocks. The first architecture of the proposed embodiments has been designed to reduce the number of trainable parameters. First the number of channels of the different layers has been limited to a small number. Most of the layers use 4 or 8 channels. This is at least four times less than R-ACE. Second, the Context Aggregation Network (CAN) conventionally found in such network is replaced by an Atrous Spatial Pyramid Pooling (ASPP). This allows to reduce significantly the number of trainable parameters while keeping the ability to gather fine-to-coarse image-level features, without the need of downsampling/upsampling operations. In embodiments of the first architecture of FIG. 2, the input layer is a 2D convolution layer with one channel in input and 4 channels in output. This layer is followed by the non-linear activation function ReLU (Rectified Linear Unit). An average 2D pooling is then applied to reduce by a factor 2 the resolution in both directions. The ASPP pyramid is then used to extract coarse to fine spatial information; the pyramid is composed of 4 levels with a dilation rate equal to 1, 2, 4 and 8, respectively. For each pyramid level, a ReLU function is used. The output levels of the pyramid are then concatenated, leading to a number of channels equal to 16. These feature maps are then upsampled to recover the initial resolution. A 2D bilinear upsampling is used. Two 2D convolution layers are finally used to decrease the number of channels from 16 to 8, and from 8 to 1, respectively. A ReLU function is used between the two convolution layers. The last channel coming from the last convolution layer is the dimming map 220 which is simply combined to the luminance of the input image 203 to form the reduced luminance Ý 260. For all convolution layers, the kernel size is 3×3.

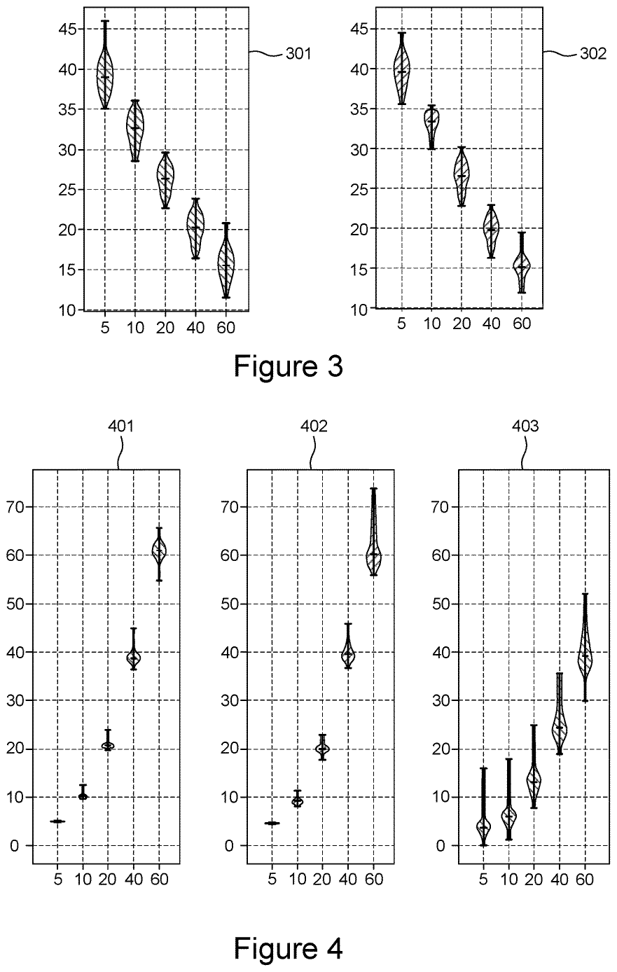

The result of this first architecture is a lightweight deep learning network comprising only nine layers, wherein most layers use 4 or 8 channels, and where the model is trained with less than 2000 trainable parameters. More exactly, in an embodiment, the number of trainable parameters is 1865, which is much less than the 29299 parameters required for R-ACE or even much higher number of parameters for other implementations, while providing surprisingly good results in view of the size of the model, as illustrated in FIGS. 3 and 4. The size needed to store the complete model, when using 32 bits per parameter, is around 12 kbytes which is very small compared to the size required for conventional architectures.

In at least one embodiment, the combination 230 between the dimming map and the input luminance is done through an addition. In this case, the dimming map comprises negative values so that the result of the combination is a reduction of the luminance. The dimming map is generated accordingly to output values for example in the range [−1, 0] in the case of normalized values or in the range of [−(2^{x}−1), 0] in the case of integer luminance values expressed on x bits. In at least one embodiment, the combination 230 between the dimming map and the input luminance is done through a subtraction. In this case, the dimming map comprises positive values so that the result of the combination is a reduction of the luminance. The dimming map is generated accordingly to output values for example in the range [0, 1] in the case of normalized values or in the range of [0, 2^{x}−1] in the case of integer luminance values expressed on x bits. In at least one embodiment, the combination 230 between the dimming map and the input luminance is done through a multiplication (scaling). In this case, the dimming map comprises values for example in the range [0;1] so that the result of the combination is a reduction of the luminance.

The training of the model of the first lightweight deep network architecture is for example performed according to a first training solution based on 4 content losses: a Mean Absolute Error (MAE) loss L_{MAE}, a perceptual error loss L_{VGG}, a power loss L_{pow} and a total variation (TV) loss L_{TV}. A second training solution is described later herein and may also be used in combination with the first architecture. The first training is done over a set of images representative of a great variety of images. In at least one embodiment 300 images were used. In the description of losses, the term image is used as a shortcut representing either the luminance part of the image or the color components of the image or a combination of luminance and chrominance of the image.

The Mean Absolute Error (MAE) loss L_{MAE} may be determined as following:

$${L}_{MAE} = \frac{1}{N} {\sum }_{i = 1}^{N} \vert {Y}_{i} - {\hat{Y}}_{i} \vert$$

Where i is the spatial coordinate of the pixel, Y is the original image and Ý is the modified image, N the total number of pixels in the image. This loss characterizes the difference of luminance between an original image and the corresponding modified image for all the pixels of the images.

The perceptual error loss L_{VGG} may be determined as following:

$${L}_{V G G} = {\sum }_{j ∈ J}^{c a r d ( J )} \frac{1}{{C}_{j} \times {H}_{j} \times {W}_{j}} {\vert {ϕ}_{j} ( y ) - {ϕ}_{j} ( \hat{Y} ) \vert}^{2}$$

where φⱼ(Y) represents the activation at the jth layer of the VGG16 network, Cⱼ represents the number of channels of this layer, Hⱼ and Wⱼ represent the height and the width of the layer respectively, J is the set of relu2_2 layers in the VGG16 network from which the visual features are extracted. It is based on the well-known Visual Geometry Group (Simonyan, Karen, and Andrew Zisserman, Very Deep Convolutional Networks for Large-Scale Image Recognition, arXiv preprint arXiv:1409.1556 (2014)) deep network model conventionally used in the domain of image classification. This model can be used for extracting image features and evaluating the degree of similarity between two images. In this context, features extracted are for example horizontal or vertical contours, interest points, texture information, specific shapes with different levels of semantic meaning. For this loss, VGG16 network that comprises 16 layers was used. This loss characterizes the differences between extracted features of an original image and the features of the corresponding modified image.

The power loss L_{pow} is based on the assumption that there is a linear relationship between emitted light (thus the luminance of the pixels of the image) and power consumption. It may be determined as follows:

$${L}_{p o w} = ‖ ( 1 - R ) \cdot {P}_{Y} - {P}_{\hat{Y}} ‖$$

It is assumed that

$${P}_{Y} = {\sum }_{i = 1}^{N} {Y}_{i}^{γ} ,$$

where γ, equal to 2.2, is used to perform the gamma correction, the predicted power is

$${P}_{\hat{Y}} = {\sum }_{i = 1}^{N} {\hat{Y}}_{i}^{γ}$$

and K, in the range 0 to 1, is the amount of energy reduction to be achieved. This loss characterizes the difference of power between an original image and the corresponding modified image for all the pixels of the images.

The total variation loss L_{TV} may be determined as follows:

$${L}_{T V} = \frac{1}{N} {\sum }_{i = 1}^{N} {( {∇}_{v} D {M}_{i} )}^{2} + {( {∇}_{h} D {M}_{i} )}^{2}$$

where ∇ᵥ and ∇ₕ represent the vertical and horizontal gradients respectively, DM is the dimming map. Although it is expressed as a loss function, L_{TV} expresses a constraint corresponding to block 250 of FIG. 2. This function is operated on the dimming map only, without any relationship to an input or output image. This loss characterizes the smoothness of the dimming map.

The network is trained by using a weighted linear combination of these four losses.

$$Total Loss = {α}_{M A E} \cdot {L}_{M A E} + {α}_{V G G} \cdot {L}_{V G G} + {α}_{p o w} \cdot {L}_{p o w} + {α}_{T V} \cdot {L}_{T V}$$

Examples of values for weights are:

$${α}_{M A E} = 1.$$

$${α}_{V G G} = 0.0 \; 625$$

$${α}_{p o w} = 1 e - 6$$

$${α}_{T V} = 1 e - 6$$

In further embodiments, different improvements can be done over this combination of losses.

The MAE and the VGG losses ensure that the network learns to generate an output image that is visually similar to the input image. In order to ensure a high-fidelity reconstruction while maintaining the QoE, these losses may be combined with additional information. A Just Noticeable Difference (JND) map can ensure that alterations to the input image remain below visibility threshold. A saliency map can protect visually important information during the training. Such maps, either JND-based or saliency-based, can be used either as another input to the network or in the computation of the losses themselves. For example, they may be used in a point-wise weighted version of the MAE, where weights come from the JND or saliency maps.

The properties of the dimming map are application dependent. In the context of a transmission of the map to a display device or low-cost storage on the display device, it might be interesting for the dimming map to be robust to downscaling and upscaling operations. The total variation loss allows to introduce such constraint when building the dimming map and brings some good properties. Test results showed that the dimming maps are much smoother with the use of TV loss. The smoothness of dimming maps makes them much more robust to down-sampling operations, which could lead to significant gains in terms of compression. However, this robustness to down-sampling/up-sampling operations could even be further increased by applying another constraint to the dimming map. This could be performed during the training with the addition of a dedicated down-sampling/up-sampling loss L_{scale} that may be determined as follows:

$${L}_{s c a l e} = \frac{1}{N} {\sum }_{i = 1}^{N} {\vert {DM}_{i} - up ( down ( {DM}_{i} ) ) \vert}^{2}$$

where up( ) and down( ) represent upscale and downscale operators, respectively. Note that the up( ) and down( ) operators could be neural networks.

An evaluation of the performance of the proposed lightweight deep network first architecture was done according to an embodiment based on luminance reduction, in other words using the architecture depicted in FIG. 2. This embodiment has been assessed on the BSD dataset, a database of human segmented natural images and its application to evaluating segmentation algorithms and measuring ecological statistics. This dataset comprises 300 images: 200 images for training and 100 for testing. The images have a resolution of 481×321, in a landscape or portrait format. The network is trained twice over the complete set of images (i.e., two epochs) using parameters conventionally used for the training of deep learning networks such as: ADAM solver, learning rate of 1e-3, weight decay of 1e-5, batch size of 1. During these first 2 epochs, to ensure the QoE of the output image, the loss function is only composed of the two first losses L_{MAE} and L_{VGG}. This first training phase converges quickly with a very good quality of reconstruction; the average PSNR value is above 50 dB. After these first two epochs, in a second training phase, the L_{pow} and the L_{TV} losses are added to further ensure the pixel value reduction and the smoothness constraint on the dimming map. Since the reconstruction is already very close to the original image thanks to the first training, the loss values induced by the L_{MAE} and L_{VGG} loss are very small in this second training, thus allowing to take into account the power loss and the smoothness constraint. The coefficients of the linear combination were empirically set to the example values introduced above (α_{MAE}=1.0, α_{VGG}=0.0625, α_{pow}=1e-6, and α_{TV}=1e-6). Performances are analyzed from different perspectives: the objective quality, the smoothness property of the dimming map, the ability to infer different pixel value reduction rates from only one training, the comparison with R-ACE network and a comparison of the actual energy gain on an OLED display.

FIG. 3 illustrates the PSNR distribution against pixel value reduction rates according to at least one embodiment using the first architecture compared to the R-ACE solution. More particularly is shows the Peak Signal to Noise Ratio (PSNR) obtained as function of the desired pixel value reduction rate for values selected among a set comprising 5%, 10%, 20%, 40%, and 60%. The graphic 301 corresponds to results of the proposed method while the graphic 302 corresponds to results of a R-ACE network-based solution. As expected, PSNR values decrease with the pixel value reduction rate, from 39.02 dB±1.98 (avg±std) to 15.55 dB±1.8 for rates 5% and 60%, respectively. For R=5%, PSNR values exhibit a very high objective quality, which is confirmed by the SSIM values of 0.99±0.001. For R>40%, the average objective quality decreases with an average PSNR of 20.2 dB and a SSIM value of 0.9. The computation of the energy consumption rate actually achieved by the proposed method exhibits a small and not significant variation around the desired target. For instance, for R=5%, the achieved actual average rate is of 4.96% with a standard deviation of 0.1.

At least one embodiment uses the L_{TV} loss function that results in much smoother dimming maps. This property is especially interesting in a context of transmission. The smoothness of dimming maps makes them much more robust to downsampling operations, which could lead to a significant gain in terms of bitrate if applied in the context of coding. To objectively evaluate this smoothness, a low-pass filter in the Fourier domain with 3 radial cutoff frequencies is applied on the maps with and without the TV loss. The Kullback-Leibler (KL) divergence between the distribution of the original map and its filtered version is then computed. Table 1 presents the average KL scores for a pixel value reduction of 20% for different cutoff frequencies. It shows a significantly smaller divergence for dimming maps computed with the TV loss.

TABLE 1

| Cutoff Frequency | 50 | 150 | 200 | 250 |
|---|---|---|---|---|
| Without TV loss | 0.0096 | 0.0041 | 0.0024 | 0.0013 |
| With TV loss | 0.0040 | 0.0020 | 0.0012 | 0.0007 |

In terms of entropy, Table 2 shows that the entropy of maps obtained with the TV loss is lower than those obtained without the TV loss. Therefore, the TV loss allows to design dimming maps that are easier to encode and much more robust to the loss of fine details.

TABLE 2

| Entropy | 5% | 10% | 20% | 40% |
|---|---|---|---|---|
| Without TV loss | 7.02 | 6.70 | 6.61 | 7.10 |
| With TV loss | 6.81 | 5.47 | 6.26 | 5.97 |

With regards to QoE, Table 3 illustrates the TV loss impact on the objective quality. According to PSNR/SSIM, the use of TV loss slightly decreases the objective quality. A loss of 0.2 dB to 0.4 dB is observed. From a subjective point of view, it is extremely difficult, if not impossible, to distinguish between those results. This difference is not judged visually significant in this context, keeping in mind that the TV loss brought interesting properties for a transmission context.

TABLE 3

| PSNR/SSIM | 5% | 10% | 20% | 40% |
|---|---|---|---|---|
| Without TV loss | 39.4/0.99 | 32.7/0.98 | 26.4/0.98 | 20.0/0.92 |
| With TV loss | 39.0/0.99 | 32.5/0.99 | 26.2/0.97 | 20.2/0.90 |

One limitation of current approaches is that models are trained for a particular pixel value reduction rate R, leading to as many models as there are pixel value reduction rates. To overcome this problem, the possibility to approximate a dimming map for the pixel value reduction rate \hat{R} given the prior knowledge of a dimming map obtained for a pixel value reduction rate R, such that R>\hat{R}, is investigated. The most straightforward approach is to consider a linear model as follows:

$$D M ( i \vert \hat{R} ) = D M ( i \vert R ) \times \frac{\hat{R}}{R}$$

The analysis is performed with a model trained with R=40%. Even though it cannot be considered be optimal both in terms of pixel value reduction and QoE preservation, the straightforward linear scaling provides interesting results. When approximating for \hat{R}=20%, the average PSNR and rate are equal to 26.19 dB and 20.7%, respectively (to be compared to 26.25 dB and 20.71%). For \hat{R}=10%, PSNR=32.21 dB and R=10.7% (to be compared to PSNR=32.58 dB and R=10.4%). For \hat{R}=5%, PSNR=38.22 dB and R=5.4% (to be compared to PSNR=39.02 dB and R=4.96%). These results underline the possibility to infer other pixel value reduction rates by linearly scaling down a single dimming map.

FIG. 4 illustrates the average pixel value reduction against target pixel value reduction rates according to at least one embodiment using the first architecture compared to the R-ACE solution. The graphic 401 corresponds to results of the proposed method based on a lightweight deep network, the graphic 402 corresponds to results of a R-ACE network-based solution. These results show that general behavior of the R-ACE network and the proposed lightweight deep network are very comparable, whether it be for PSNR values as seen in FIG. 3 or rate reduction as shown here. However, the lightweight deep network model according to the embodiments reaches these results while only requiring a significantly lower number of parameters (1.865 instead of 29.299). In addition, the proposed model does not require to condition the network's architecture with the desired pixel value reduction rate, which brings even more flexibility in its use.

The graphic 403 corresponds to the observed actual energy reduction rate on an OLED display. For this graphic, a wattmeter was used to measure the energy consumption of the original test images and their corresponding processed versions by the proposed method on an OLED 55″ HD display. There is a significant difference from the theoretical energy consumption gain. This difference may be induced by the display technology used in the test display device. Indeed, this device is using a RGBW screen where each pixel is made of four LEDs (red, green, blue, and white). A more complex power model would be required to fully master the energy consumption reduction for such display technology. However, despite this difference, a significant energy consumption is measured when using the proposed pixel value reduction embodiments, while maintaining a satisfying QoE.

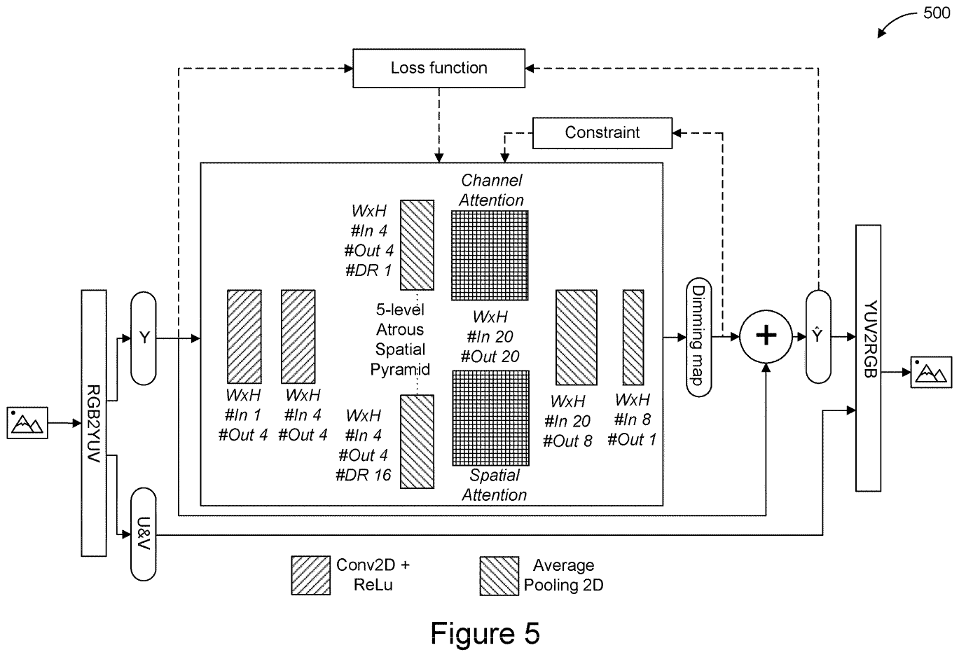

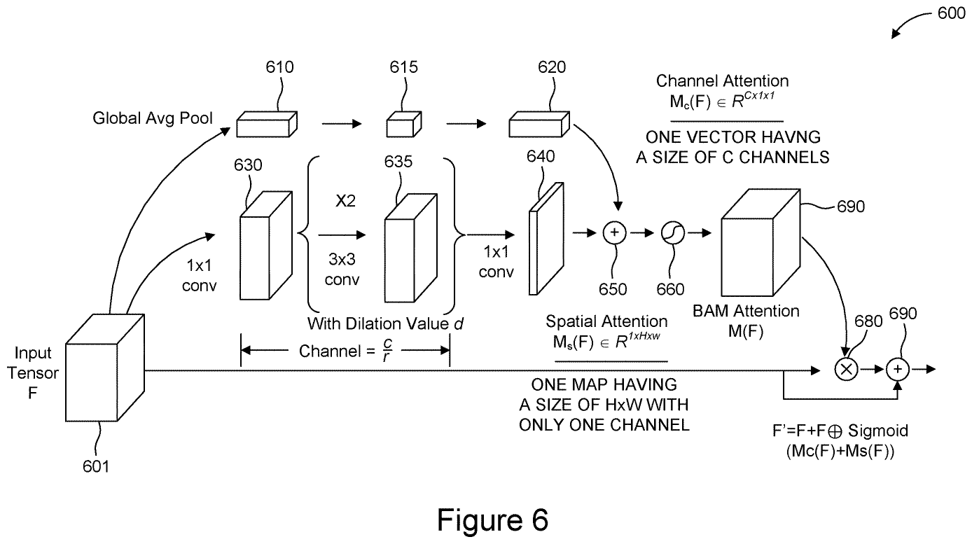

FIG. 5 illustrates a second example of a general architecture based on a lightweight deep network for generating a dimming map according to at least one embodiment. The second architecture 500 is based on the first architecture 200 of FIG. 2 modified to take into account both spatial attention and channel attention mechanism, as described in relation with FIG. 6. A second modification is the use of an additional level for the Atrous Spatial Pyramid Pooling, leading to a 5-level ASPP. Another modification is that, unlike the first architecture, the resolution used for the global average pooling is not reduced to let more freedom to the spatial attention mechanism. In other words, each level of the ASPP uses an input whose resolution is W×H. The other elements are equivalent so that the description of these elements is identical to the same elements in FIG. 2.

FIG. 6 illustrates an example of combination of channel attention and spatial attention. Such a mechanism has been proposed in Park, Jongchan, et al. “Bam: Bottleneck attention module.” arXiv preprint arXiv:1807.06514 (2018) but is here adapted to the second lightweight deep network architecture of FIG. 5. The input 601 of the channel and spatial attention mechanism is the output of the ASPP.

The main idea of the channel attention map is to put emphasis on some channels. The weights are learned during the training procedure. The first step 610 squeezes the spatial dimension of the input feature maps. For instance, in this context, the dimension of the input feature maps is W×H. There are 20 feature maps considering that there are 5 pyramid levels, each composed of 4 channels. After the squeezing process, there is a vector of size 20. Indeed, an average pooling is used to reduce a map of resolution W×H to a scalar value. The main idea is now to transform this vector to another one that represents the importance of the different maps. For that, two convolution layers are used in step 615. The first reduces the dimension by a factor (by default the factor is 2). A ReLU activation is used. The second layer recovers the original dimension of the vector. The activation layer is a sigmoid to ensure that the weights are positive and in the range of [0,1]. In step 620, the final vector is upsampled back to recover the initial depth of the input feature maps. Each channel is composed of only one constant value.

The main idea of the spatial attention map is to give more importance to some locations of the feature maps compared to others. The process is exactly the same as described in Park et al. In short, in step 630, the feature F of size C×H×W is projected into a reduced dimension C/r×H×W (where r by default is equal to 2) using 1×1 convolution to integrate and compress the feature map across the channel dimension. After the reduction, in step 635, two 3×3 dilated convolutions are applied to utilize contextual information effectively. Finally, the features are again reduced to 1×H×W spatial attention map using 1×1 convolution in step 640.

The output of such channel and spatial attention mechanisms are combined together, in step 650, through an element-wise summation. In step 660, a sigmoid operation allows to map the values into a small range, for example between 0 and 1, leading to a combined attention map 670. This is combined with the input into a new set of feature maps F′, in step 680 and 690, such that:

$${F}^{′} = F + F ⊗ M ( F )$$

where F is the set of input feature maps, ⊗ is the pixel wise operation and M is the combination of spatial and channel attentions into an attention map, defined as:

$$M = σ ( {M}_{c} ( F ) + {M}_{s} ( F ) )$$

where σ is the sigmoid operation, M_{c} represents the channel attention map and Mₛ represents the spatial attention map.

In an embodiment of this second architecture using a combined channel and spatial attention mechanism, the number of trainable parameters is 4832. This value is larger compared to the first architecture, but this is still far less than state-of-the-art methods.

The training of the model of the first or second lightweight deep network architecture is for example performed according to a second training solution based on 4 content losses: a Mean Absolute Error (MAE) loss L_{MAE}, a structural similarity index measure loss L_{SSIM}, a power loss L_{pow} and a total variation (TV) loss L_{TV}. Compared to the first training method, the VGG loss is replaced by the structural similarity index measure (SSIM) loss that characterizes the difference between an input image and the corresponding modified image. The SSIM formula is based on three comparison measurements (i.e., luminance, contrast and structure). This relies on local average, local variance and local covariance. The loss is given by one minus the SSIM value. With this second training solution, the network is trained by using a weighted linear combination of these four losses:

$$Total Loss = {α}_{M A E} \cdot {L}_{M A E} + {α}_{V G G} \cdot {L}_{V G G} + {α}_{p o w} \cdot {L}_{p o w} + {α}_{T V} \cdot {L}_{T V}$$

The Mean Absolute Error loss L_{MAE} and the total variation loss L_{TV} are identical to the losses of the first training method. The power loss L_{pow} is slightly modified here to be invariant to the resolution:

$${L}_{p o w} = ‖ ( 1 - R ) \cdot {P}_{Y} - {P}_{\hat{Y}} ‖ , where {P}_{Y} = \frac{1}{N} {\sum }_{i = 1}^{N} {Y}_{i}^{γ} ,$$

where N is the number of pixels in the image.

The SSIM loss is given by:

$${L}_{s s i m} = 1 - S S iM ( Y , \hat{Y} )$$

where SSIM is the well-known full-reference quality metric proposed in Wang, Zhou, et al. “Image quality assessment: from error visibility to structural similarity.” IEEE transactions on image processing 13.4 (2004): 600-612. SSIM is in the range [0,1], where 1 indicates the maximum value.

Examples of values for the weights of the losses are:

$${α}_{M A E} = 1.$$

$${α}_{SSIM} = 0.5$$

$${α}_{p o w} = 2000$$

$${α}_{T V} = 10$$

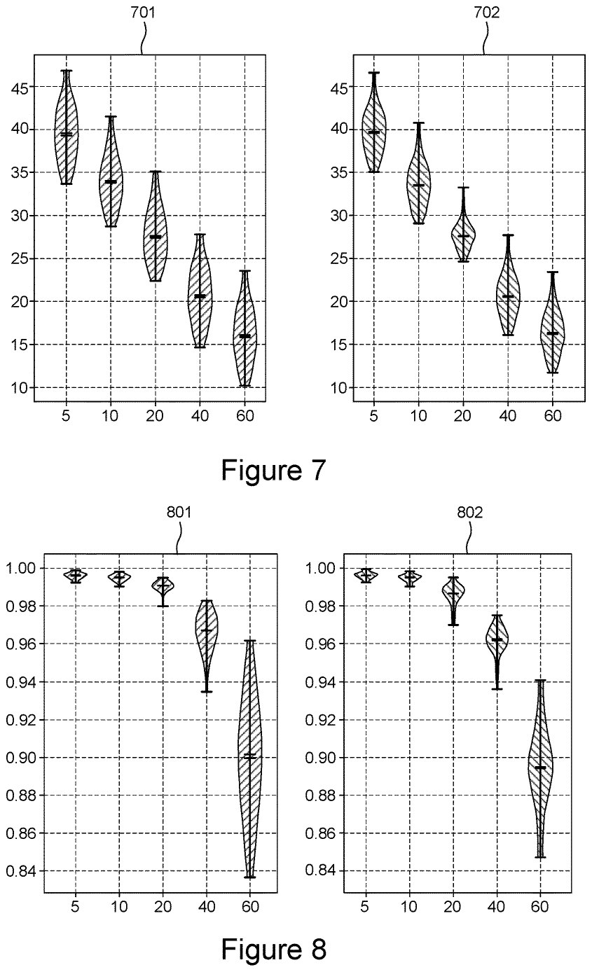

The use of an average operator in the power loss allows to be invariant to the resolution. This feature is especially interesting for performing the training over small patches, such as 128×128, rather than over complete images. Working on patches allows to perform data augmentation by randomly sampling patches within images of training dataset. The test results of FIGS. 7 to 10 show the results of a training according to the second training method performed on a set of 40000 patches.

FIG. 7 illustrates a PSNR diagram according to at least one embodiment using the second architecture compared to the R-ACE solution. The graphic 701 corresponds to results of the proposed method based on a lightweight deep network using the second architecture and the graphic 702 corresponds to results of a R-ACE network-based solution and shows the Peak Signal to Noise Ratio (PSNR) obtained as function of the desired pixel value reduction rate for values selected among a set comprising 5%, 10%, 20%, 40%, and 60%.

As expected, the PSNR is decreasing with the desired pixel value reduction rate for both architectures. The proposed architecture performs slightly better than the R-ACE solution, while, in the meantime, it requires much fewer trainable parameters.

FIG. 8 illustrates a SSIM diagram according to at least one embodiment using the second architecture compared to the R-ACE solution. The graphic 801 corresponds to results of the proposed method based on a lightweight deep network using the second architecture and the graphic 802 corresponds to results of a R-ACE network-based solution and shows the structural similarity index measure obtained as function of the desired pixel value reduction rate for values selected among a set comprising 5%, 10%, 20%, 40%, and 60%.

Compared to the assessment of PSNR, a similar trend can be seen in the SSIM metrics. Performances of both solutions are close with a slight advantage for the proposed one, while the proposed method being far less complex than the R-ACE method.

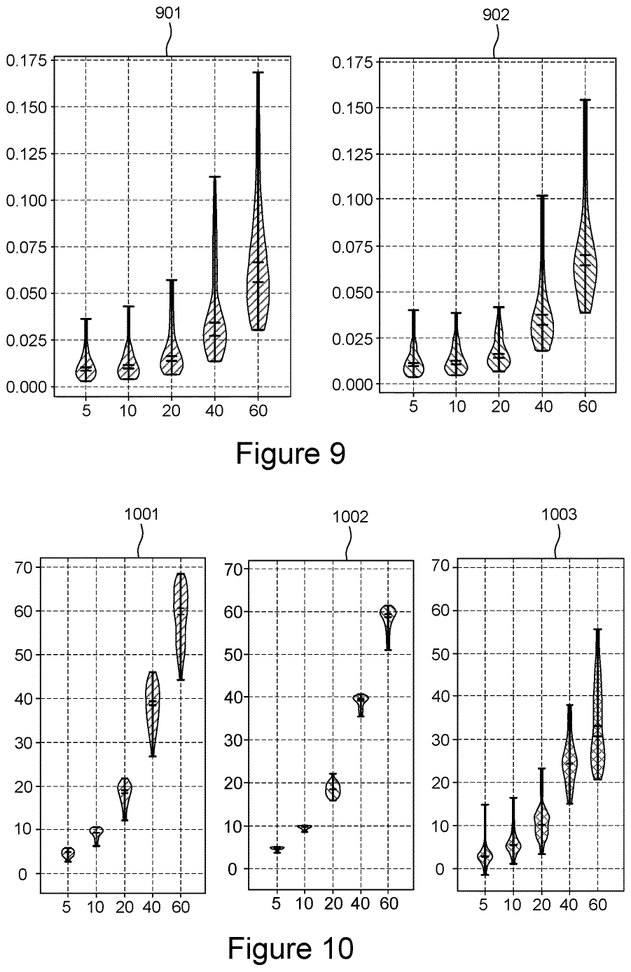

FIG. 9 illustrates a LPIPS diagram according to at least one embodiment using the second architecture compared to the R-ACE solution. The graphic 901 corresponds to results of the proposed method based on a lightweight deep network using the second architecture and the graphic 902 corresponds to results of a R-ACE network-based solution and shows the Learned Perceptual Image Patch Similarity (LPIPS) obtained as function of the desired pixel value reduction rate for values selected among a set comprising 5%, 10%, 20%, 40%, and 60%.

Previous observations are again validated with this third quality metric.

FIG. 10 illustrates an average pixel value reduction against target pixel value reduction rates according to at least one embodiment using the second architecture compared to the R-ACE solution. The graphic 1001 corresponds to results of the proposed method based on a lightweight deep network using the second architecture and the graphic 1002 corresponds to results of a R-ACE network-based solution and shows the energy consumption reduction obtained as function of the desired pixel value reduction rate for values selected among a set comprising 5%, 10%, 20%, 40%, and 60%.

Like in FIG. 4, the graphic 1003 corresponds to the observed actual energy reduction rate on an OLED display. The graphic 1003 presents the actual energy consumption rate of modified images (the power consumption is measured on an RGBW OLED screen). It is interesting to observe that there is a discrepancy between the desired energy consumption rate and the actual measured screen power. This difference is due to the used energy model. This model assumes that the amount of energy consumed by an OLED screen is linearly correlated with the luminance values. This assumption turns out to be valid for RGB OLED but does not hold for RGBW OLED screens. A better energy model would be required to improve this accuracy.

In terms of entropy, Table 4 shows that the entropy of maps obtained using the second architecture with the TV loss is lower than those obtained without the TV loss. Therefore, the TV loss allows to design dimming maps that are easier to encode and much more robust to the loss of fine details.

TABLE 4

| Entropy | 5% | 10% | 20% | 40% | 60% |
|---|---|---|---|---|---|
| Without TV loss | 2.13 | 3.00 | 4.00 | 5.07 | 5.90 |
| With TV loss | 2.13 | 2.85 | 3.81 | 5.01 | 5.78 |

With regards to QoE, Table 5 illustrates the TV loss impact on the objective quality when using the second architecture. According to PSNR/SSIM, the use of TV loss slightly decreases the objective quality. An average loss of less than 0.3 dB is observed. In terms of SSIM, the loss is even smaller (0.01). As with the first architecture, from a subjective point of view, it is extremely difficult, if not impossible, to distinguish between those results. This difference is not judged visually significant in our context, keeping in mind that the TV loss brought interesting properties for a transmission context.

TABLE 5

| PSNR/SSIM | 5% | 10% | 20% | 40% | 60% |
|---|---|---|---|---|---|
| Without TV loss | 39.3/0.99 | 33.8/0.99 | 27.2/0.98 | 20.7/0.97 | 16.0/0.89 |
| With TV loss | 39.6/0.99 | 33.9/0.99 | 27.6/0.99 | 20.7/0.96 | 16.0/0.89 |

Embodiments described above with reference to FIG. 2 or FIG. 5 correspond to luminance-based solutions. In variant embodiments, these principles are extended to apply to chrominance. In other words, it is proposed to reduce the energy required for displaying the image by reducing the levels of the chrominance (e.g., UV values 204 of FIG. 2) of the input image. This is preferably done in combination with a reduction of the luminance, thus reducing both the Y and UV values. In at least one variant embodiment, two dimming maps, one from the luminance and one from the chrominance information can be inferred jointly from the network. In at least another embodiment, the chrominance dimming map is inferred from the luminance-based dimming map. In a variant embodiment, three dimming maps are used, one for the luminance and one for each chrominance channel. The same principles as those described herein with respect to the luminance-based solution can be applied to chrominance-based embodiments.

In variant embodiments, the same principles are extended to apply to color components. In other words, it is proposed to reduce the energy required for displaying the image by reducing the color levels (e.g., RGB values) of the color components of the input image. The training method, described above as operating on the luminance information, can be adapted to operate on the color information. For example, in at least one variant embodiment, a single dimming map is generated for all three colors. In another variant embodiment, 3 separate dimming maps (one for each color) could be used. In a variant embodiment, the dimming map is learned on luminance component and used to reduce the values of the color components. The same principles than those described herein with respect to the luminance-based solution can be applied to color components-based embodiments.

The same principles apply also on other color spaces e.g., HSV, Lab.

Embodiments are described above as an image-based solution. However, the same principles can be applied to other media (e.g., immersive 360° content, point clouds, 3D contents, videos). For the latter, a simple frame by frame processing can be envisioned, enhanced with some further temporal filtering of the output dimming maps.

Embodiments described herein are based on a training of the network that is done once for a target reduction rate R₁. For rates smaller than R₁, the proposed embodiments allow to linearly scale the dimming map in order to achieve other reduction rates. This is a significant difference compared to state-of-the-art methods. In this use-case, although not optimal in terms of QoE, it can be guaranteed that there will be no artefact generation. In another embodiment, inferring a higher rate reduction from the one used during the training is also possible but without the guarantee on the QoE and artifact creation. In addition, if two dimming maps with different target reduction rates (R₁ and R₂) are defined, a further interpolation between these maps would lead to the estimated dimming map given the desired rate R, such that R₁<R<R₂.

In at least one embodiment, multiple trainings sessions are done on different image categories representing different type of contents (for example: outdoor landscapes, cities, images with persons, gaming environments, user interface graphics, etc.) and depending on the image category the corresponding network is used to produce a more specific dimming map.

In at least one embodiment, the dimming map is modulated pixel-wise by side information such as region-of-interest, gaze tracking information, etc.

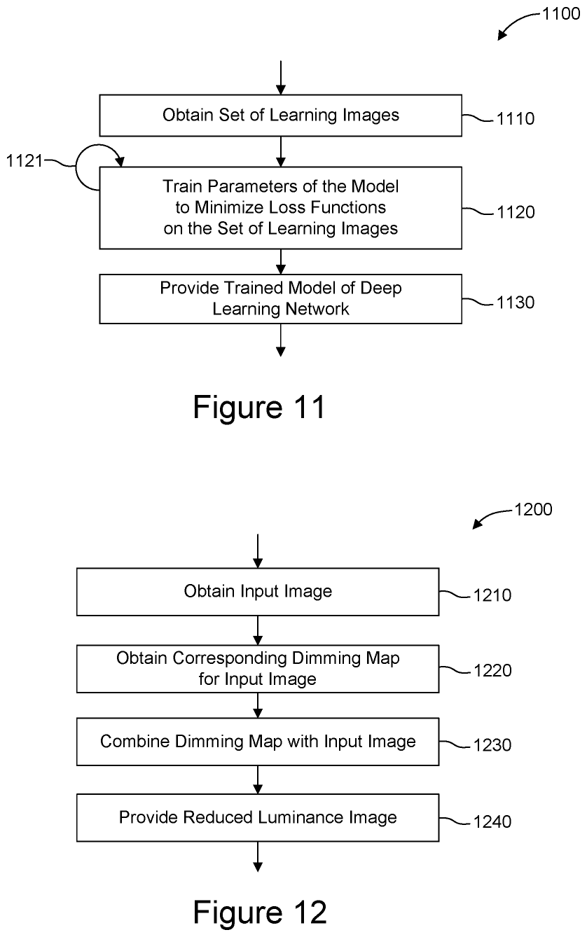

FIG. 11 illustrates an example process for training a lightweight deep learning model according to at least one embodiment. Such process 1100 is for example implemented by a processor 101 of device 100 and may use any of the two training methods described above. In step 1110, the processor obtains a set of images in the case of the first training method or a set of patches in the case of the second training method, to be used as a training data set. In step 1120, parameters of the lightweight deep learning model are learned by iterating (step 1121) on the images or patches of the data set, while minimizing the loss functions and enforcing the constraint as described above. This results, in step 1130, into a trained model of deep learning network for reducing the pixel value of an input image, that can be provided to be used, for example as described in FIG. 12.

FIG. 12 illustrates an example process for generating an image with reduced pixel value based on a lightweight deep learning model according to at least one embodiment. Such process 1200 is for example implemented by a processor 101 of device 100 and may use any of the two architectures described above. In step 1210, an input image is obtained. In step 1220, a dimming map corresponding to the input image is obtained. Both data items may be obtained for example from a data provider 180 through a communication network 150 or loaded from local storage 106 of the device 100. In step 1230, the dimming map is combined with the input image. This results in the generation of an image with reduced pixel value compared to the input image. In step 1240, the dimmed image may then be provided to another device or displayed on the display unit 103 of the device 100. Compared to displaying the original input image, the display of the dimmed image allows to reduce the energy consumption of the display device, while keeping a satisfying quality of experience. In variant embodiments, the pixel value reduction is done either by reducing the luminance or the luminance and the chrominance or the color components of the input image.

Embodiments described above are particularly adapted to OLED displays. The techniques may also apply to LCD screen. In this context, a further process is applied on the dimming map to compute a value to control the backlight of the LCD screen. This value is for example a minimal or median or maximal value of the dimming map or may be dependent on the expected quality of experience.

Although different embodiments have been described separately, any combination of the embodiments together can be done while respecting the principles of the disclosure.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising:
obtaining an input image;
obtaining a dimming map determined for the input image using a deep learning network;
combining the input image with the dimming map to obtain a modified image; and
providing the modified image,
wherein the deep learning network is configured to provide the dimming map based on the input image and wherein combining the dimming map with the input image provides a modified image with reduced values of pixels.

2. (canceled)

3. The method of claim 1, wherein combining the dimming map with the input image modifies a luminance of the input image, and wherein a model of the deep learning network is trained with multiple losses comprising at least:
a mean absolute error characterizing a difference of luminance between an input image and the corresponding modified image;
a perceptual error loss characterizing a difference between extracted features of an input image and extracted features of the corresponding modified image;
a power loss characterizing a difference of power between an input image and a corresponding modified image; and
a total variation loss characterizing a smoothness of the dimming map.

4-10. (canceled)

11. The method of claim 3, wherein the model of the deep learning network is trained with less than 2000 trainable parameters.

12. (canceled)

13. The method of claim 3, wherein the model of the deep learning network uses an architecture having only nine layers.

14. (canceled)

15. The method of claim 3, wherein the model of the deep learning network uses an architecture having only eleven layers.

16. (canceled)

17. The method of claim 3, wherein most layers of the deep learning network use four or eight channels.

18. The method of claim 3, wherein the model of the deep learning network uses a spatial pyramid pooling layer.

19-23. (canceled)

24. A device comprising a processor configured to:
obtain an input image;
obtain a dimming map determined for the input image using a deep learning network;
combine the input image with the dimming map to obtain a modified image; and
provide the modified image,
wherein the deep learning network is configured to provide the dimming map based on the input image, and wherein combining the dimming map with the input image provides a modified image with reduced values of pixels.

25. (canceled)

26. A non-transitory computer readable storage medium comprising stored instructions that when executed by a processor, cause the processor to:
obtain an input image;
obtain a dimming map determined for the input image using a deep learning network;
combine the input image with the dimming map to obtain a modified image; and
provide the modified image,
wherein the deep learning network is configured to provide the dimming map based on the input image, and wherein combining the dimming map with the input image provides a modified image with reduced values of pixels.

27. The device of claim 24, wherein combining the dimming map with the input image modifies a luminance of the input image, and wherein a model of the deep learning network is trained with multiple losses comprising at least:
a mean absolute error characterizing a difference of luminance between an input image and the corresponding modified image;
a perceptual error loss characterizing a difference between extracted features of an input image and extracted features of the corresponding modified image;
a power loss characterizing a difference of power between an input image and a corresponding modified image; and
a total variation loss characterizing a smoothness of the dimming map.

28. The device of claim 27, wherein the model of the deep learning network is trained with less than 2000 trainable parameters.

29. The device of claim 27, wherein the model of the deep learning network uses an architecture having only nine layers.

30. The device of claim 27, wherein the model of the deep learning network uses an architecture having only eleven layers.

31. The device of claim 27, wherein most layers of the deep learning network use four or eight channels.

32. The device of claim 27, wherein the model of the deep learning network uses a spatial pyramid pooling layer.

33. The non-transitory computer readable storage medium of claim 26, wherein combining the dimming map with the input image modifies a luminance of the input image, and wherein a model of the deep learning network is trained with multiple losses comprising at least:
a mean absolute error characterizing a difference of luminance between an input image and the corresponding modified image;
a perceptual error loss characterizing a difference between extracted features of an input image and extracted features of the corresponding modified image;
a power loss characterizing a difference of power between an input image and a corresponding modified image; and
a total variation loss characterizing a smoothness of the dimming map.

34. The non-transitory computer readable storage medium of claim 33, wherein the model of the deep learning network is trained with less than 2000 trainable parameters.

35. The non-transitory computer readable storage medium of claim 33, wherein the model of the deep learning network uses an architecture having only nine layers.

36. The non-transitory computer readable storage medium of claim 33, wherein most layers of the deep learning network use four or eight channels.

37. The non-transitory computer readable storage medium of claim 33, wherein the model of the deep learning network uses a spatial pyramid pooling layer.
